(19) United States
(12) Patent Application Publication
(10) Pub. No.: US 2022/0245061 A1
(43) Pub. Date: Aug. 4, 2022

(54) QUALIFICATION EVALUATING DEVICE AND QUALIFICATION EVALUATING METHOD

(71) Applicant: SHIMADZU CORPORATION, Kyoto (JP)

(72) Inventor: Yumi AKAI, Kyoto (JP)

(21) Appl. No.: 17/582,356

(22) Filed: Jan. 24, 2022

(30) Foreign Application Priority Data
Feb. 3, 2021 (JP) 2021-015562

(51) Int. Cl. G06F 11/36

(52) U.S. Cl. CPC G06F 11/3688; G06F 11/3692; G06F 11/3664; G06F 11/368

(57) ABSTRACT

A qualification evaluating device includes a receiver configured to be capable of receiving selection of a plurality of system tests for performing operational qualification evaluation in regard to a plurality of analysis systems constituted by the analysis device, an acquirer that acquires details of evaluation to be performed in the plurality of system tests received by the receiver as a plurality of evaluation information pieces, a presenter that presents details of advance preparation to be carried out before execution of the plurality of system tests based on the plurality of acquired evaluation information pieces, an execution controller that controls the analysis device such that the plurality of system tests are executed after the advance preparation for the plurality of system tests is completed, and an outputter that outputs results of the plurality of system tests executed by the execution controller.

### BACKGROUND

### Technical Field

The present invention relates to a qualification evaluating device and a qualification evaluating method.

### Description of Related Art

Generally, a qualification evaluating test for checking whether an analysis device runs normally is executed by a field engineer (hereinafter referred to as an inspection performer) after the analysis device is installed. The qualification evaluating test is referred to as validation. Various devices for automating part of the qualification evaluating test have been suggested. For example, JP 2014-029282 A describes an analysis-device validation device that automatically validates an analysis device. Further, WO 2020/065804 A1 describes a qualification automatic determination system for automating operational qualification determination of components that constitute an analysis system. Further, WO 2020/044517 A1 describes a validation device that validates analysis control software.

### SUMMARY

In recent years, software for creating a report after operational qualification evaluation is performed automatically has been developed. In a case where such software is used, it is necessary to carry out advance preparation work such as preparation of various solutions and a standard sample to be used for evaluation and selection of an executable file. It is necessary for the inspection performer to carry out advance preparation work before executing software for the operational qualification evaluation.

A plurality of detectors may be attached to one analysis device, thereby constituting a plurality of analysis systems. In a case where the operational qualification evaluation in regard to a plurality of such analysis systems are performed with use of the above-mentioned software or the like, the inspection performer carries out advance preparation work before the operational qualification evaluation in regard to each analysis system. Thus, it is difficult to automatically perform the operational qualification evaluation in regard to the plurality of analysis systems at night, for example. Thus, overall efficiency of the operational qualification evaluation in regard to the plurality of analysis systems is degraded.

An object of the present invention is to provide a qualification evaluating device and a qualification evaluating method that enable efficient operational qualification evaluation in regard to a plurality of analysis systems.

A qualification evaluating device according to one aspect that performs operational qualification evaluation in regard to an analysis device includes a receiver configured to be capable of receiving selection of a plurality of system tests for performing operational qualification evaluation in regard to a plurality of analysis systems constituted by the analysis device, an acquirer that acquires details of evaluation to be performed in the plurality of system tests received by the receiver as a plurality of evaluation information pieces, a presenter that presents details of advance preparation to be carried out before execution of the plurality of system tests based on the plurality of acquired evaluation information pieces, an execution controller that controls the analysis device such that the plurality of system tests are executed after the advance preparation for the plurality of system tests is completed, and an outputter that outputs results of the plurality of system tests executed by the execution controller.

A qualification evaluating method according to another aspect for performing operational qualification evaluation in regard to an analysis device includes receiving selection of a plurality of system tests for performing operational qualification evaluation in regard to a plurality of analysis systems constituted by the analysis device, acquiring details of evaluation to be performed in the plurality of received system tests as a plurality of evaluation information pieces, presenting details of advance preparation to be carried out before execution of the plurality of system tests based on the plurality of acquired evaluation information pieces, controlling the analysis device such that the plurality of system tests are executed after the advance preparation for the plurality of system tests is completed, and outputting results of the plurality of executed system tests.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a diagram showing the configuration of an analysis device according to one embodiment;

FIG. 2 is a diagram showing the configuration of an analysis control device of FIG. 1;

FIG. 3 is a diagram showing one example of a plurality of operation screens displayed in a display by a qualification evaluating device;

FIG. 4 is a diagram showing one example of the plurality of operation screens displayed in the display by the qualification evaluating device;

FIG. 5 is a diagram showing one example of the plurality of operation screens displayed in the display by the qualification evaluating device;

FIG. 6 is a diagram showing one example of the plurality of operation screens displayed in the display by the qualification evaluating device;

FIG. 7 is a block diagram showing the functional configuration of the qualification evaluating device;

FIG. 8 is a flowchart showing one example of running of the qualification evaluating device of FIG. 2;

FIG. 9 is a flowchart showing one example of running of the qualification evaluating device of FIG. 2;

FIG. 10 is a flowchart showing one example of running of the qualification evaluating device of FIG. 2; and

FIG. 11 is a flowchart showing parallel execution of first and second system tests.

### DETAILED DESCRIPTION

A qualification evaluating device according to embodiments of the present invention will be described below in detail with reference to the drawings.

### (1) Configuration of Analysis Device and Analysis Control Device

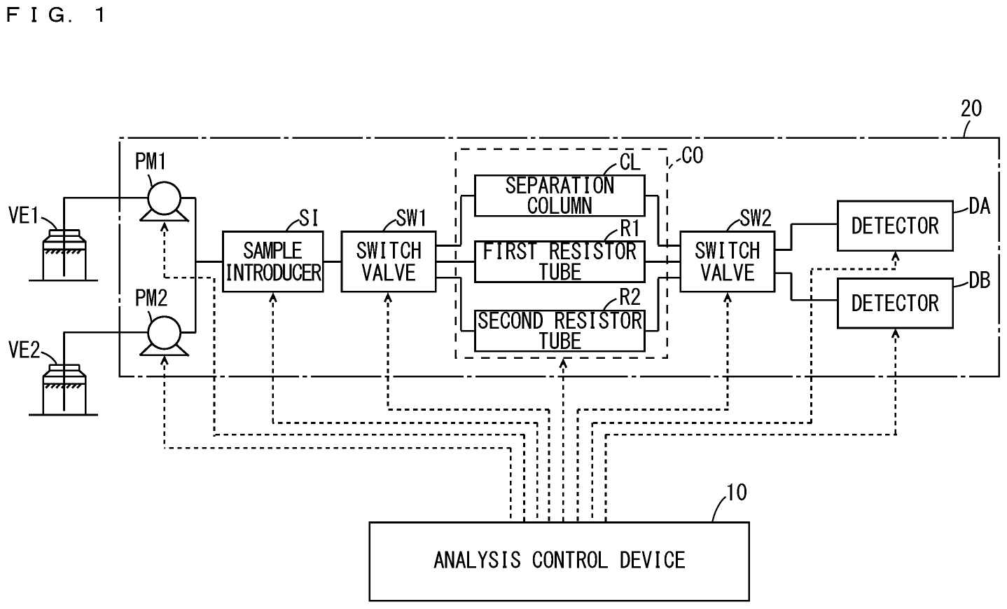

FIG. 1 is a diagram showing the configuration of an analysis device according to one embodiment. In the present embodiment, the analysis device 20 is a liquid chromatograph. The analysis device 20 includes pumps PM1, PM2, a sample introducer SI, a switch valve SW1, a separation column CL, a first resistor tube R1, a second resistor tube R2, a column oven CO, a switch valve SW2, a detector DA and a detector DB.

The pumps PM1, PM2 guide mobile phases contained in mobile phase containers VE1, VE2 to the sample introducer SI. The sample introducer SI introduces a sample into the guided mobile phases. The sample introducer SI is an autosampler, for example. In the present embodiment, the switch valve SW1 has one liquid inlet port and three liquid outlet ports. The sample introducer SI supplies the mobile phases and the sample to the liquid inlet port of the switch valve SW1.

The separation column CL separates the sample in the mobile phases into components. The first and second resistor tubes R1, R2 are used for the operational qualification evaluation in regard to the detector DA. In the present example, the first and second resistor tubes R1, R2 are configured to be attachable between the switch valve SW1 and the switch valve SW2 to be in parallel with the separation column CL. An inspection performer attaches the first and second resistor tubes R1, R2 the switch valve SW1 and the switch valve SW2 when the operational qualification evaluation in regard to the detector DA is performed. The separation column CL, the first resistor tube R1 and the second resistor tube R2 are contained in the column oven CO.

Three pipes for guiding liquid to the separation column CL, the first resistor tube R1 and the second resistor tube R2 are respectively connected to the three liquid outlet ports of the switch valve SW1. The switch valve SW1 is configured to be switchable to selectively introduce the mobile phases and the sample supplied from the sample introducer SI to any one of the three pipes.

In the present embodiment, the switch valve SW2 has three liquid inlet ports and two liquid outlet ports. Three pipes for guiding liquid led out from the separation column CL, the first resistor tube R1 and the second resistor tube R2 are respectively connected to the three liquid inlet ports of the switch valve SW2. Two pipes for guiding liquid to the detector DA and the detector DB are respectively connected to the two liquid outlet ports of the switch valve SW2. The switch valve SW2 is configured to be switchable to selectively introduce the mobile phases and the sample guided by the separation column CL, the first resistor tube R1 or the second resistor tube R2 to the detector DA or the detector DB.

The detector DA and the detector DB detect sample components introduced through the switch valve SW2. In the analysis device 20 of FIG. 1, a first analysis system using the detector DA and a second analysis system using the detector DB are constituted. The detectors DA, DB are an ultraviolet visible light detector, a photodiode array detector, a fluorescence detector, an electrical conductance detector, a differential refractometer and an evaporative light scattering detector, for example. In the present embodiment, the detector DA is a photodiode array detector, and the detector DB is a fluorescence detector.

Here, a test for performing the operational qualification evaluation of the first and second analysis systems is referred to as a system test. In the present embodiment, the system test includes one or a plurality of tests from among an absorbance linearity test, a gradient concentration test, an injection linearity test, a carryover test and a reproducibility test, for example. The absorbance linearity test is a test for checking that the concentration of a sample that has been introduced into the detectors DA, DB and a signal intensity are proportional to each other. The gradient concentration test is a test for checking optimality of composition of an eluent. The injection linearity test is a test for checking that an amount of a sample introduced from the sample introducer SI and signal intensities in the detectors DA, DB are proportional to each other. The carryover test is a test for detecting a carryover value. The reproducibility test is a test for checking reproducibility of a result of sample analysis.

In the present embodiment, one system test for performing the operational qualification evaluation of the first analysis system including the detector DA is referred to as a first system test, and one system test for performing the operational qualification evaluation of the second analysis system including the detector DB is referred to as a second system test.

An analysis control device 10 controls the running of the pumps PM1, PM2, the sample introducer SI, the switch valve SW1, the column oven CO, the switch valve SW2, the detector DA and the detector DB. The analysis control device 10 includes a qualification evaluating device 100, described below, for automatically performing operational qualification evaluation.

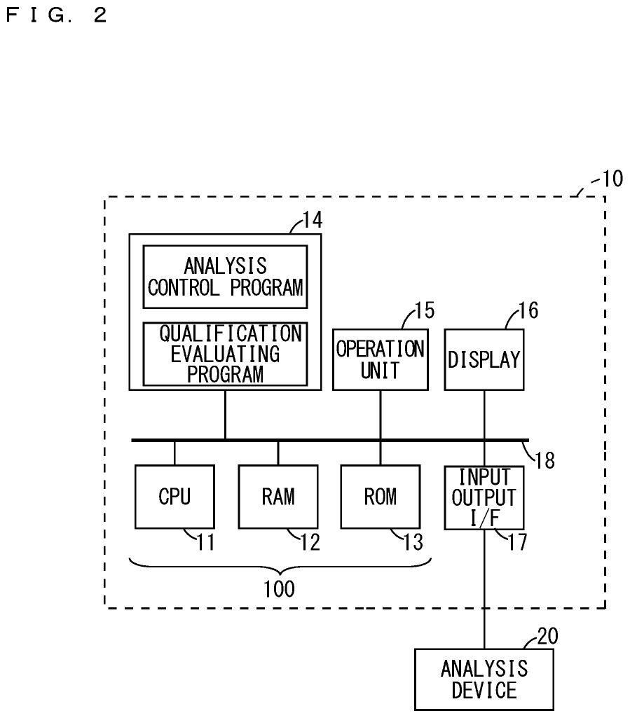

FIG. 2 is a diagram showing the configuration of the analysis control device 10 of FIG. 1. The analysis control device 10 is constituted by a CPU (Central Processing Unit) 11, a RAM (Random Access Memory) 12, a ROM (Read Only Memory) 13, a storage 14, an operation unit 15, a display 16 and an input output I/F (interface) 17. The CPU 11, the RAM 12, the ROM 13, the storage 14, the operation unit 15, the display 16 and the input output I/F 17 are connected to a bus 18. The CPU 11, the RAM 12 and the ROM 13 constitute the qualification evaluating device 100.

The RAM 12 is used as a work area for the CPU 11. A system program is stored in the ROM 13. The storage 14 includes a storage medium such as a hard disc or a semiconductor memory. An analysis control program is stored in the storage 14. The CPU 11 executes the analysis control program stored in the storage 14 or the like on the RAM 12, so that the analysis device 20 is controlled. Further, a qualification evaluating program is stored in the storage 14. The qualification evaluating program may be stored in a storage medium different from the storage 14. The CPU 11 executes the qualification evaluating program stored in the storage 14 or the like on the RAM 12. Thus, the operational qualification evaluation of the analysis device 20 of FIG. 1 is performed by the analysis control device 10 through the input output I/F 17.

The operation unit 15 is an input device such as a keyboard, a mouse or a touch panel. The display 16 is a display device such as a liquid crystal display device. The inspection performer can provide various instructions to the qualification evaluating device 100 using the operation unit 15. The display 16 displays various screens or the like for the operational qualification evaluation performed by the qualification evaluating device 100. The input output I/F 17 outputs various instructions from the CPU 11 or the operation unit 15 to the analysis device 20 and inputs various data to the CPU 11 from the analysis device 20.

### (2) Advance Preparation for System Test

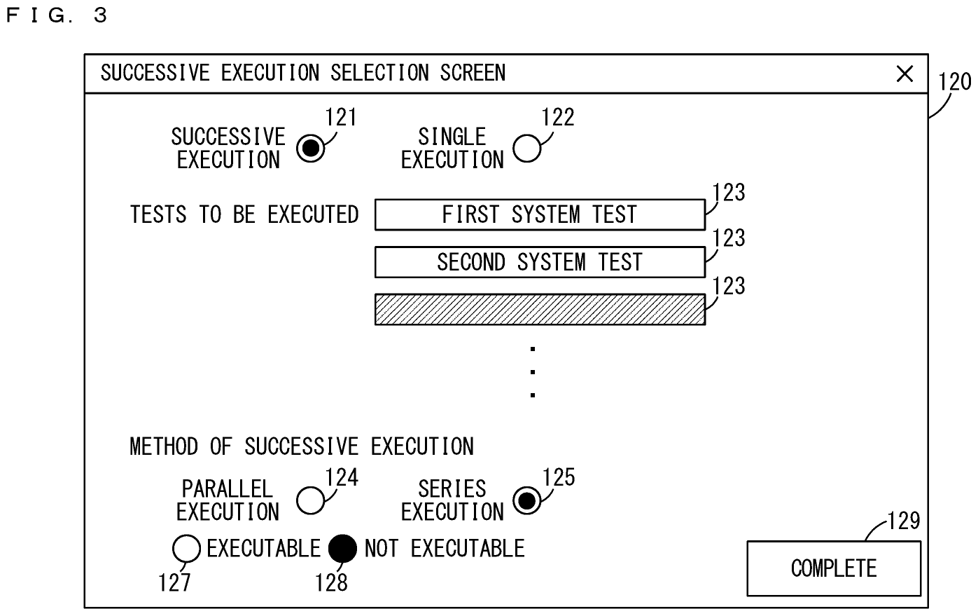

FIGS. 3 to 6 are diagrams showing one example of a plurality of operation screens displayed in the display 16 by the qualification evaluating device 100. A successive execution selection screen 120 is shown in FIG. 3. As shown in FIG. 3, the successive execution selection screen 120 includes selection buttons 121, 122, a plurality of selection fields 123, selection buttons 124, 125, a parallel executability display portions 127, 128 and a complete button 129.

The selection buttons 121, 122 are operated for selection in regard to whether a plurality of system tests are to be executed successively. In a case where the inspection performer designates the selection button 121, the plurality of system tests are executed successively. In a case where the inspection performer designates the selection button 122, a single system test is executed. In the present example, the selection button 121 is selected.

The inspection performer can select a system test to be executed by designating one or a plurality of selection fields 123. In the present example, the first system test and the second system test are selected by designation of two selection fields 123. During selection of a test to be executed, selectable system tests are displayed in each selection field 123 with use of a pull-down menu, for example.

The selection buttons 124, 125 are selectable in a case where the selection button 121 is selected. The selection buttons 124, 125 are operated for selection of parallel execution or series execution in regard to the plurality of system tests. The parallel execution refers to temporal execution of the plurality of system tests in parallel. The series execution refers to temporal execution of the plurality of system tests in series. The parallel executability display portions 127, 128 display executability of parallel execution. In a case where the parallel executability display portion 127 lights up, parallel execution is executable. In a case where parallel executability display portion 128 lights up, parallel execution is not executable. In the present example, it is displayed that parallel execution of the first system test and the second system test is not executable. In this case, the inspection performer can select only the selection button 125.

In a case where the parallel executability display portion 127 lights up, the inspection performer can select either one of the selection buttons 124, 125. One of the selection buttons 124, 125 may be selected automatically based on a plurality of system tests selected in the selection fields 123.

In a case where the selection button 125 is selected, the switch valve SW2 is switched sequentially such that a mobile phase and a sample are guided to either one of the detector DA and the detector DB in the analysis device 20 of FIG. 1. Thus, the first and second system tests are executed in this order. On the other hand, in a case where the selection button 124 is selected, the switch valve SW2 is switched such that a mobile phase and a sample are simultaneously guided to the detector DA and the detector DB in the analysis device 20 of FIG. 1. In this state, the first and second system tests are executed simultaneously.

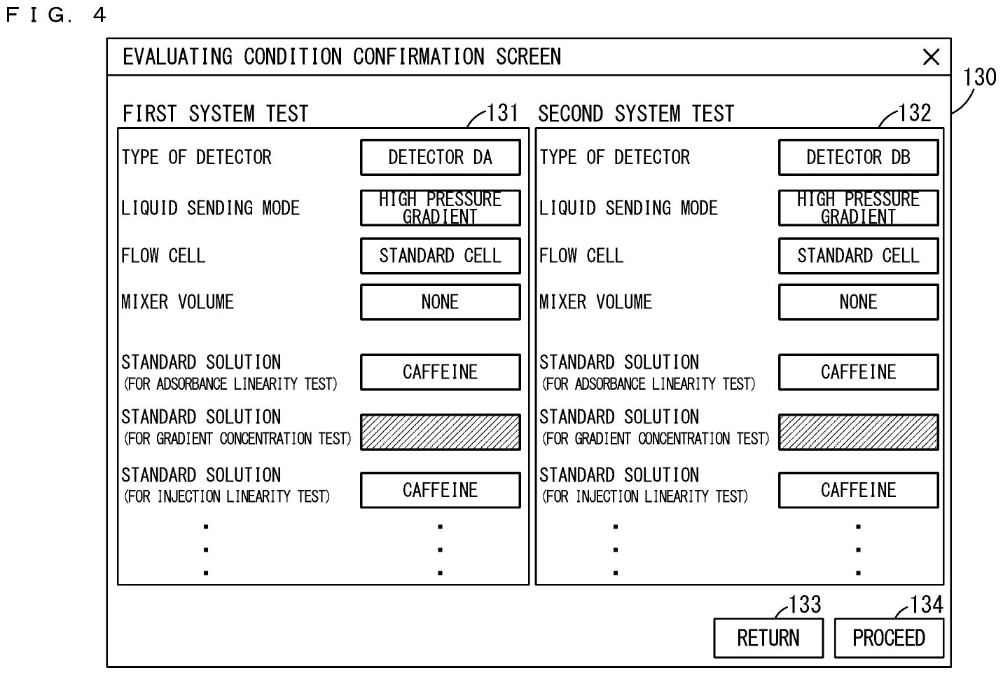

When the inspection performer operates the complete button 129, an evaluating condition confirmation screen 130 shown in FIG. 4 is displayed in the display 16. As shown in FIG. 4, the evaluating condition confirmation screen 130 includes a first confirmation window 131, a second confirmation window 132, a return button 133 and a proceed button 134. Respective evaluating conditions for the respective first and second system tests are displayed in the first and second confirmation windows 131, 132.

In regard to the evaluating condition for the first system test of the present example, the “detector DA” is displayed as a detector. “High pressure gradient” is displayed as a liquid sending mode for the pumps PM1, PM2. A “standard cell” is displayed as a flow cell in the detector. In the present example, because a mixer is not used in the analysis device 20, the mixer volume of the sample introducer SI is displayed as “none.” “Caffeine” is displayed as a standard solution (standard sample) for the absorbance linearity test, the gradient concentration test and the injection linearity test.

In regard to the evaluating condition for the second system test of the present example, the “detector DB” is displayed as a detector. “High pressure gradient” is displayed as a liquid sending mode for the pumps PM1, PM2. A “standard cell” is displayed as a flow cell in the detector. “None” is displayed in regard to the mixer volume of the sample introducer SI. “Caffeine” is displayed as a standard solution for the absorbance linearity test and the injection linearity test.

The inspection performer confirms the evaluating conditions of the analysis device 20 of FIG. 1 in accordance with the display in the first and second confirmation windows 131, 132. When ending confirmation of the evaluating conditions, the inspection performer operates the proceed button 134. In a case where changing an item that has been selected in the successive execution selection screen 120 of FIG. 3, the inspection performer operates the return button 133. When the return button 133 is operated, the successive execution selection screen 120 of FIG. 3 is re-displayed.

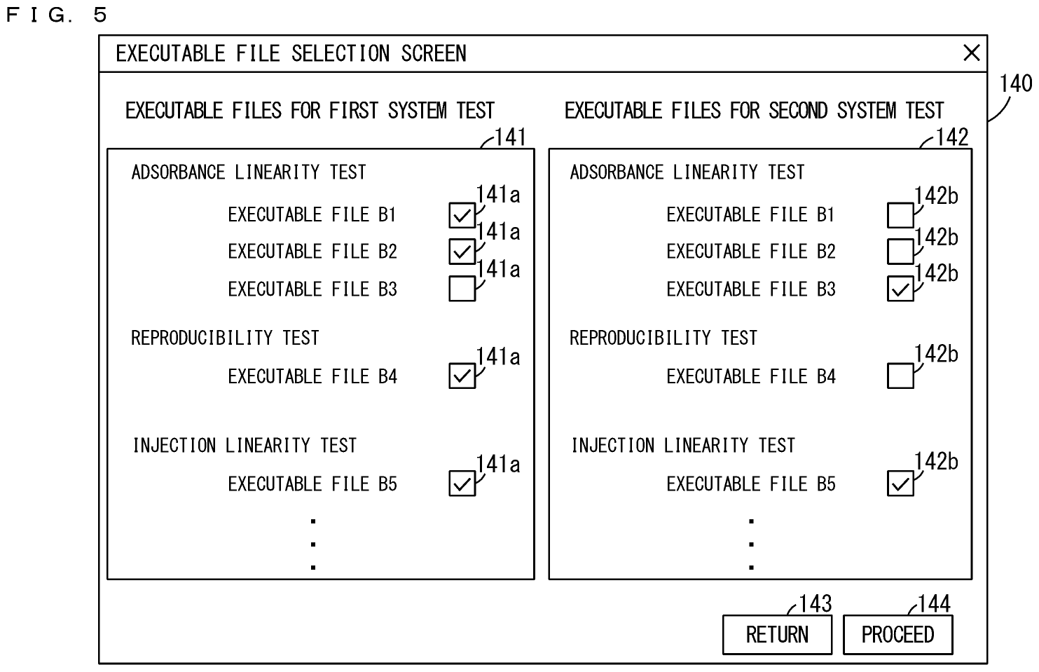

When the inspection performer operates the proceed button 134, an executable file selection screen 140 shown in FIG. 5 is displayed in the display 16. As shown in FIG. 5, the executable file selection screen 140 includes a first file selection window 141, a second file selection window 142, a return button 143 and a proceed button 144.

Here, an executable file will be described. In the present example, an executable file is a batch file. A batch file is a text file including a plurality of instructions. In the present embodiment, each executable file is used for execution of a system test. For example, executable files B1 to B3 are prepared for execution of the absorbance linearity test. Further, an executable file B4 is prepared for execution of the reproducibility test. Further, an executable file B5 is prepared for execution of the injection linearity test.

In the first and second file selection windows 141, 142, a plurality of selection fields 141a, 142a for selection of one or a plurality of executable files are displayed. When the first and second system tests are selected as the tests to be executed in FIG. 3, executable files to be used for execution of first and second system tests are selected automatically. The inspection performer can change executable files to be used for the first and second system tests by selecting the selection fields 142a, 142b corresponding to desired executable files in the first and second file selection windows 141, 142.

In the first system test of the present example, the executable files B1, B2 for the absorbance linearity test, the executable file B4 for the reproducibility test and the executable file B5 for the injection linearity test are selected. In the second system test of the present example, the executable file B3 of the absorbance linearity test and the executable file B5 for the injection linearity test are selected.

When confirmation or a change in regard to the executable files in the first and second file selection windows 141, 142 ends, the inspection performer operates the proceed button 144. In the evaluating condition confirmation screen 130 of FIG. 4, when the return button 143 is operated, the evaluating condition confirmation screen 130 of FIG. 4 is re-displayed in the display 16.

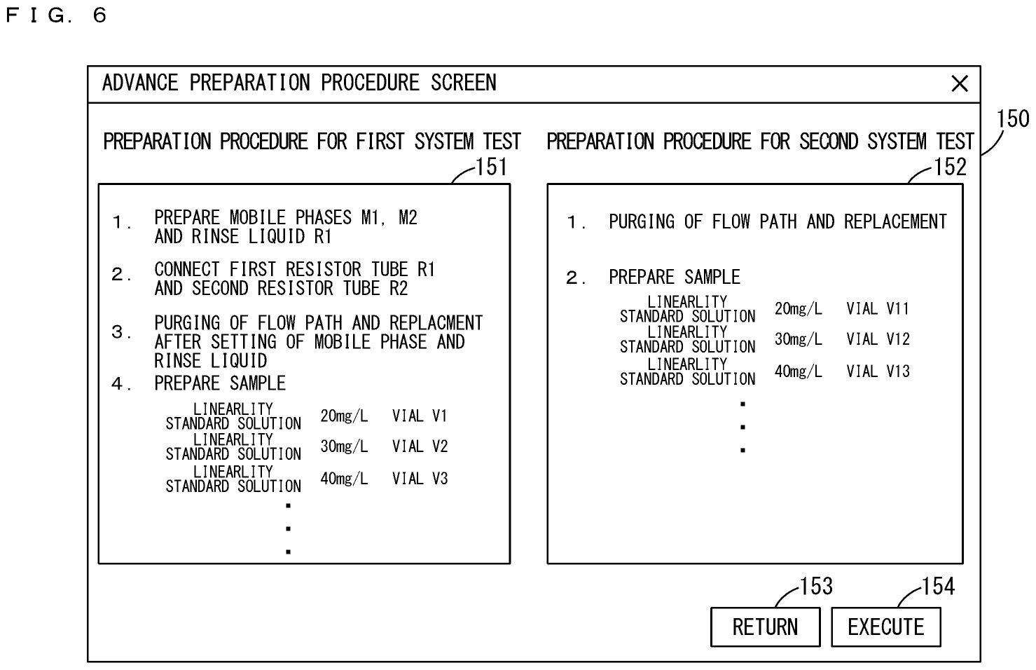

When the inspection performer operates the proceed button 144, an advance preparation procedure screen 150 shown in FIG. 6 is displayed in the display 16. As shown in FIG. 6, the advance preparation procedure screen 150 includes a first preparation procedure window 151, a second preparation procedure window 152, a return button 153 and an execution button 154.

In the first and second preparation procedure windows 151, 153, the preparation procedures to be performed by the inspection performer before the first and second system tests are displayed. The preparation procedure includes preparation of a mobile phase, preparation of a resistor tube, preparation of a flow path, preparation of a sample, etc. The inspection performer prepares for the first and second system tests of the analysis device 20 of FIG. 1 in accordance with the preparation procedures displayed in the first and second preparation procedure windows 151, 152.

In the first preparation procedure window 151 of the present example, preparation of mobile phases M1, M2 and a rinse liquid RI, connecting of the resistor tubes R1, R2 of FIG. 1, purging of liquid remaining in the flow path including the detector DA using a rinse liquid and replacing the rinse liquid with a mobile phase after setting of the mobile phases M1, M2 and the rinse liquid RI and preparation of a sample are displayed as the preparation procedure for the first system test. As the preparation of a sample, preparation of a plurality of vials V1, V2, V3 for containing linearity standard solutions having different concentrations is displayed.

In the second preparation procedure window 152 of the present example, purging of the flow path including the detector DB and replacement of the rinse liquid with a mobile phase, and preparation of a sample, are displayed as the preparation procedure for the second system test. As preparation of a sample, preparation of a plurality of vials V11, V12, V13 for containing linearity standard solutions having different concentrations in the sample introducer SI is displayed.

The inspection performer carries out the advance preparation for the first and second system tests in accordance with the preparation procedures displayed in the first and second preparation procedure windows 151, 152. When the advance preparation for the first and second system tests ends, the inspection performer operates the execution button 154. Thus, successive testing of the first and second system tests is started. In the advance preparation procedure screen 150 of FIG. 6, when the return button 153 is operated, the executable file selection screen 140 of FIG. 5 is re-displayed in the display 16.

### (3) Functional Configuration of Qualification Evaluating Device 100

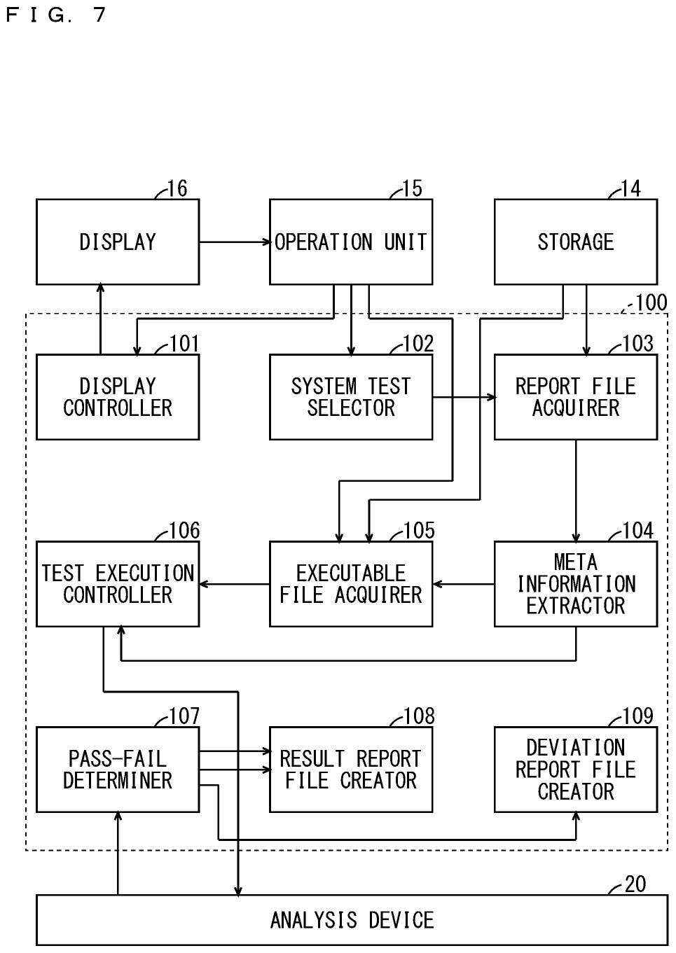

FIG. 7 is a block diagram showing the functional configuration of the qualification evaluating device 100. The qualification evaluating device 100 includes a display controller 101, a system test selector 102, a report file acquirer 103, a meta information extractor 104, an executable file acquirer 105, a test execution controller 106, a pass-fail determiner 107, a report file creator 108 and a deviation report file creator 109. The constituent elements (101 to 109) of the qualification evaluating device 100 are implemented by execution of a qualification evaluating program stored in the storage 14 by the CPU 11 of FIG. 2. Part or all of the constituent elements (101 to 109) of the qualification evaluating device 100 may be implemented by hardware such as an electronic circuit.

The display controller 101 displays the operation screens of FIGS. 3 to 6 in the display 16. Further, the display controller 101 determines whether a selection button to be selected has been selected and whether a button to be operated has been operated in the operation screens of FIGS. 3 to 6. The system test selector 102 selects one or a plurality of system tests from among a plurality of prepared system tests based on an operation of the operation unit 15 by the inspection performer. In the example of FIG. 3, the system test selector 102 selects the first and second system tests selected in the selection fields 123 of the successive execution selection screen 120 of FIG. 3.

In the storage 14, a plurality of report files corresponding to a plurality of system tests are stored, and a plurality of executable files are stored. The report file acquirer 103 acquires one or a plurality of report files corresponding to one or a plurality of system tests selected by the system test selector 102 from the storage 14. Each report file includes an unrecorded report region and unrecorded meta information representing a result of corresponding system test. Meta information includes evaluation information such as details of evaluation, an executable file to be used, a preparation procedure and so on in a corresponding system test. The details of evaluation include an evaluation item, an evaluation procedure, an evaluating condition value, a reference value and so on. In the example of FIG. 3, the report file acquirer 103 acquires report files corresponding to the first and second system tests.

The meta information extractor 104 extracts meta information included in one or a plurality of report files acquired by the report file acquirer 103. In the example of FIG. 3, meta information pieces corresponding to the first and second system tests are respectively extracted. The executable file acquirer 105 acquires an executable file to be used in one or a plurality of system tests selected by the system test selector 102 from the storage 14 based on the meta information pieces extracted by the meta information extractor 104. In the example of FIG. 5, the executable file acquirer 105 acquires executable files to be used in the first and second system tests selected in the executable file selection screen 140.

The test execution controller 106 controls the analysis device 20 such that one or a plurality of system tests selected by the system test selector 102 are executed based on one or a plurality of executable files acquired by the executable file acquirer 105 and the meta information pieces extracted by the meta information extractor 104. The pass-fail determiner 107 determines whether the results of the first and second system tests indicate passing or failing based on a chromatogram generated by output signals of the detectors DA, DB of the analysis device 20.

In a case where the pass-fail determiner 107 determines that the results of the first and second system tests indicate passing, the report file creator 108 records the results in blank report regions of the report files acquired by the report file acquirer 103. Thus, the report files are created. The deviation report file creator 109 creates deviation report files, described below, in a case where the pass-fail determiner 107 determines that the results of the first and second system tests indicate failing.

### (4) Running of Qualification Evaluating Device 100

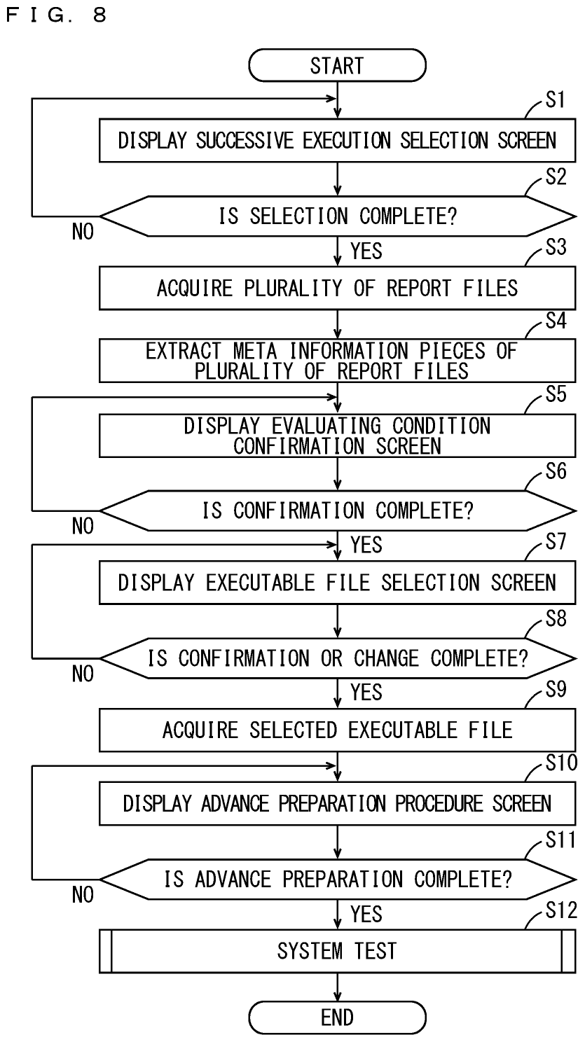

FIGS. 8 to 10 are flowcharts showing one example of the running of the qualification evaluating device 100 of FIG. 2. First, as shown in FIG. 8, the display controller 101 displays the successive execution selection screen 120 of FIG. 3 in the display 16 (step S1). The system test selector 102 selects one or a plurality of system tests based on a user's operation of the operation unit 15. Subsequently, the system test selector 102 determines whether selection is complete in the successive execution selection screen 120 (step S2). In this case, the system test selector 102 determines whether selection is complete based on whether the complete button 129 of FIG. 3 is operated. In a case where selection in the successive execution selection screen 120 is not complete, the system test selector 102 repeats determination of the step S1.

In a case where selection in the successive execution selection screen 120 is complete, the report file acquirer 103 acquires one or a plurality of report files corresponding to one or a plurality of system tests selected by the system test selector 102 from the storage 14 (step S3). In the example of FIG. 3, the report file acquirer 103 acquires the first and second report files respectively corresponding to the first and second system tests. In a case where the storage 14 stores one report file for the first and second system tests, the report file acquirer 103 may acquire the report file.

The meta information extractor 104 extracts meta information included in one or a plurality of report files acquired by the report file acquirer 103 (step S4). In the example of FIG. 3, the meta information extractor 104 extracts first and second meta information pieces included in the first and second report files.

The display controller 101 displays the evaluating condition confirmation screen 130 of FIG. 4 in the display 16 based on the meta information pieces extracted by the meta information extractor 104 (step S5). In the example of FIG. 4, the evaluating condition confirmation screen 130 includes the first and second confirmation windows 131, 132.

The display controller 101 determines whether confirmation in regard to the details of evaluation displayed in the evaluating condition confirmation screen 130 is complete (step S6). In this case, the display controller 101 determines whether confirmation in regard to the details of evaluation is complete based on whether the proceed button 134 of FIG. 3 has been operated. In a case where confirmation in regard to the details of evaluation displayed in the evaluating condition confirmation screen 130 is not complete, the display controller 101 repeats the determination of the step S5.

In a case where confirmation in regard to the details of evaluation displayed in the evaluating condition confirmation screen 130 is complete, the display controller 101 displays the executable file selection screen 140 of FIG. 5 in the display 16 (step S7). In the example of FIG. 5, the executable file selection screen 140 includes the first and second file selection windows 141, 142. The inspection performer confirms or changes a plurality of executable files displayed in the executable file selection screen 140. The display controller 101 determines whether confirmation or a change in the executable file selection screen 140 is complete (step S8). In this case, the display controller 101 determines whether confirmation or a change in the executable file selection screen 140 is complete based on whether the proceed button 144 of FIG. 5 has been operated. In a case where confirmation or a change in the executable file selection screen 140 is not complete, the display controller 101 repeats the determination of the step S7.

In a case where confirmation or a change in the executable file selection screen 140 is complete, the executable file acquirer 105 acquires one or a plurality of executable files selected in the executable file selection screen 140 from the storage 14 (step S9).

Thereafter, the display controller 101 displays the advance preparation procedure screen 150 of FIG. 6 in the display 16 (step S10). In the example of FIG. 6, the advance preparation procedure screen 150 includes the first and second preparation procedure windows 151, 152. The inspection performer carries out advance preparation for one or a plurality of system tests in accordance with a preparation procedure displayed in the advance preparation procedure screen 150. In the example of FIG. 6, the inspection performer carries out the advance preparation for the first system test in accordance with the display contents in the first preparation procedure window 151 and carries out the advance preparation for the second system test in accordance with the display contents in the second preparation procedure window 152. The display controller 101 determines whether the advance preparation is complete based on the display contents in the advance preparation procedure screen 150 (step S11). In this case, the display controller 101 determines whether the advance preparation is complete based on whether the execution button 154 of FIG. 6 has been operated. In a case where the advance preparation is not complete, the display controller 101 repeats determination of the step S10.

In a case where preparation of the analysis device 20 is completed based on the advance preparation procedure displayed in the executable file selection screen 140, the test execution controller 106, the pass-fail determiner 107, the report file creator 108 and the deviation report file creator 109 control the analysis device 20 such that one or a plurality of system test are executed (step S12). In the example of FIGS. 3 to 6, the first and second system tests are executed.

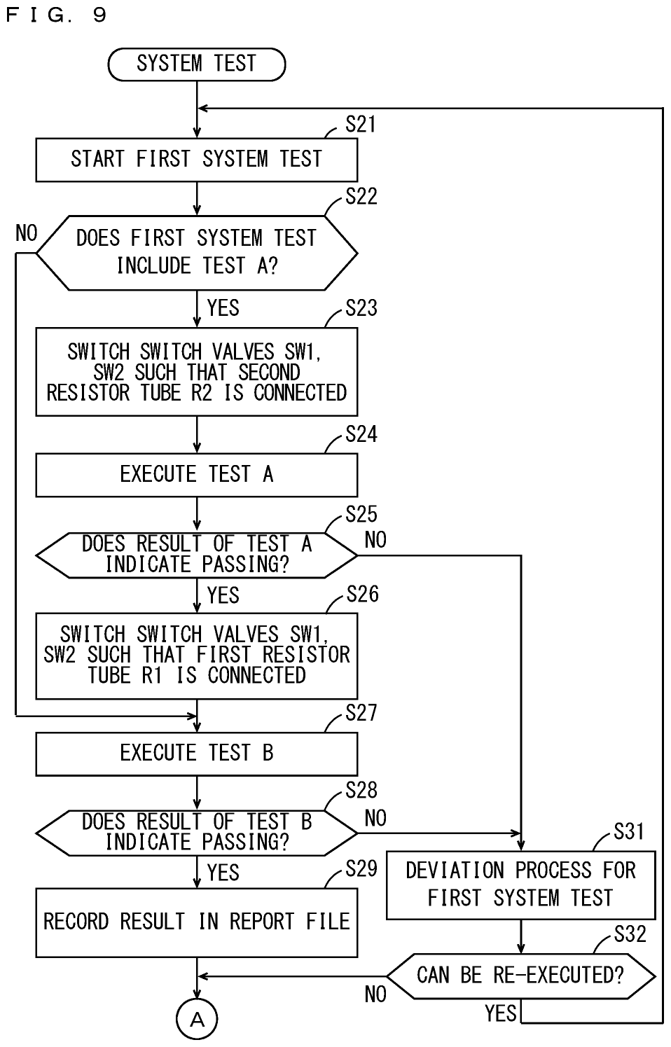

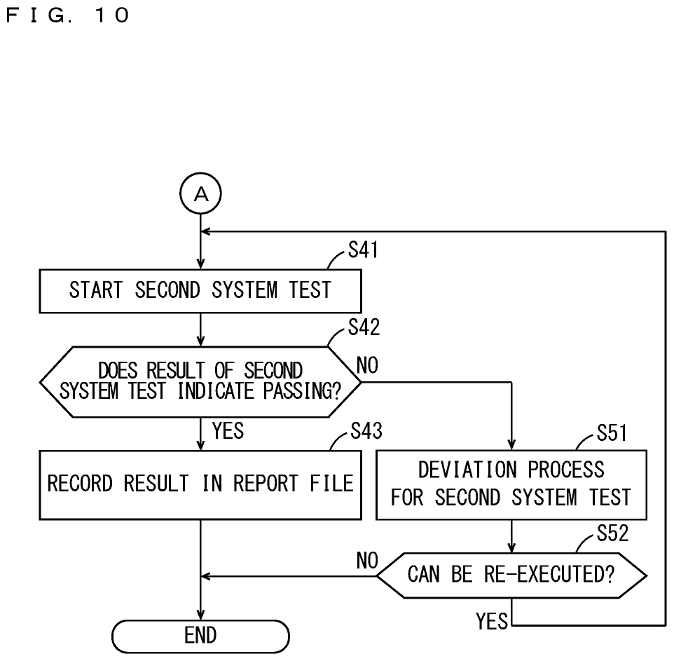

FIGS. 9 and 10 show the running of series execution of the first and second system tests. In the present example, the first system test includes both of the test A and the test B or only the test B. In the test A, the second resistor tube R2 of FIG. 1 is used. In the test B, the first resistor tube R1 of FIG. 1 is used. In the second system test, the first resistor tube R1 of FIG. 1 is used.

First, the test execution controller 106 starts the first system test (the step S21 of FIG. 9). When the first system test is started, the test execution controller 106 switches the switch valve SW2 such that the detector DA of FIG. 1 is connected to the first resistor tube R1.

The test execution controller 106 determines whether the first system test includes the test A (step S22). In a case where the first system test does not include the test A, the test execution controller 106 proceeds to the step S27, described below. In a case where the first system test includes the test A, the test execution controller 106 switches the switch valves SW1, SW2 such that the second resistor tube R2 is connected to the sample introducer SI and the detector DA (step S23). In this state, the test execution controller 106 controls the analysis device 20 such that the test A is executed (step S24). The pass-fail determiner 107 determines whether a result of the test A indicates passing (step S25).

In a case where the result of the test A does not indicate passing, the deviation report file creator 109 executes a deviation process in regard to the first system test (step S31). The deviation process of the system test includes creation of a deviation report file representing that the result of the test A indicates failing. The deviation report file creator 109 stores the deviation report file in the storage 14. The test execution controller 106 determines whether the first system test can be re-executed (step S32). In a case where the first system test can be re-executed, the test execution controller 106 returns to the step S21 after a restoration process. Thus, the test A is re-executed.

Here, one example of the restoration process will be described. For example, in a case where a spike-like noise signal appears in a chromatogram generated by the test A, a result of the test A indicates failing. It is determined that a spike-like noise signal causes bubbles in a pipe. Therefore, it is determined that the first system test can be re-executed. In this case, as the restoration process, a mobile phase is supplied into the pipe at high supply pressures applied by the pumps PM1, PM2. Thus, bubbles in the pipe are removed. In a case where the first system test cannot be re-executed in the step S32, the process proceeds to the step S41, described below.

In a case where a result of the test A indicates passing in the step S25, the test execution controller 106 switches the switch valves SW1, SW2 such that the second resistor tube R2 is connected to the sample introducer SI and the detector DA (step S26). In this state, the test execution controller 106 controls the analysis device 20 such that the test B is executed (step S27). The pass-fail determiner 107 determines whether a result of the test B indicates passing (step S28). In a case where the result of the test B does not indicate passing, the test execution controller 106 proceeds to the step S31. In this case, a deviation report file representing that the result of the test B indicates failing is created to be stored in the storage 14.

In a case where the result of the test B indicates passing, the report file creator 108 records a result of the first system test in a report file (step S29). In this case, it is recorded in the report file that the result of the first system test indicates passing.

The test execution controller 106 starts the second system test (the step S41 of FIG. 10). In this case, the first resistor tube R1 is connected to the sample introducer SI in the step S26. When the second system test is started, the test execution controller 106 switches the switch valve SW2 such that the detector DB is connected to the first resistor tube R1. In this state, the test execution controller 106 controls the analysis device 20 such that the second system test is executed.

The pass-fail determiner 107 determines whether a result of the second system test indicates passing (step S42). In a case where the result of the second system test does not indicate passing, the deviation report file creator 109 executes a deviation process in regard to the second system test (step S51). The deviation process in regard to the second system test includes creation of a deviation report file representing that the result of the second system test indicates failing. The deviation report file creator 109 stores the deviation report file in the storage 14. The test execution controller 106 determines whether the second system test is can be re-executed (step S52). In a case where the second system test can be re-executed, the test execution controller 106 returns to the step S41 after executing the above-mentioned restoration process.

In a case where the result of the second system test indicates passing, the report file creator 108 records a result of the second system test in a report file (step S43). In this case, it is recorded in the report file that the result of the second system test indicates passing. The report file creator 108 stores the report file in the storage 14.

In a case where the second system test cannot be re-executed in the step S52, the test execution controller 106 ends the second system test.

### (5) Effects of Embodiments

With the qualification evaluating device according to the above-mentioned embodiment, the evaluating condition confirmation screen 130 (FIG. 4), the executable file selection screen 140 (FIG. 5) and the advance preparation procedure screen 150 (FIG. 6) in regard to a plurality of system tests are displayed in the display 16. The inspection performer can carry out advance preparation in one go for the plurality of system tests in accordance with the contents in the operation screens of FIGS. 4 to 6 displayed in the display 16 before successive execution of the plurality of system tests. Therefore, it is not necessary for the inspection performer to carry out advance preparation for other system tests after execution of one system test. Therefore, even when the inspection performer is not present such as at night or on holidays, for example, a plurality of system tests can be executed. Therefore, the plurality of system tests can be executed successively and automatically. As a result, operational qualification evaluation in regard to a plurality of analysis systems can be performed efficiently.

Further, because the details of the advance preparation (FIGS. 4 to 6) for the plurality of system tests are displayed, the inspection performer can visually identify the details of the advance preparation. This reduces a burden on the inspection performer as a result.

Further, the separation column CL or the resistor tubes R1, R2 used for the plurality of system tests are connected automatically and selectively to any one of the detector DA and the detector DB. Thus, it is not necessary for the inspection performer to connect the separation column CL or any one of the resistor tubes R1, R2 for another system test after execution of one of the plurality of system tests. Therefore, even when the inspection performer is not present, a plurality of system tests that require switching of the separation column CL or each of the resistor tubes R1, R2 can be executed automatically.

Further, even in a case where a result of one system test out of a plurality of system tests indicates failing, another system test is continued. Thus, the plurality of system tests are executed more efficiently.

Further, in a case where a result of one system test out of a plurality of system tests indicates failing, the system test the result of which indicates failing is re-executed automatically. Thus, it is not necessary for the inspection performer to re-execute the system test the result of which indicates failing. Thus, a plurality of system tests are executed automatically without work of the inspection performer such that the results of the plurality of system tests indicate passing. As a result, operational qualification evaluation in regard to a plurality of analysis system can be performed more efficiently.

Further, because a plurality of system tests are controlled to be temporally executable in parallel or in series, the total period of time required for the plurality of system tests can be reduced in accordance with the details of the plurality of system tests.

### (6) Other Embodiments

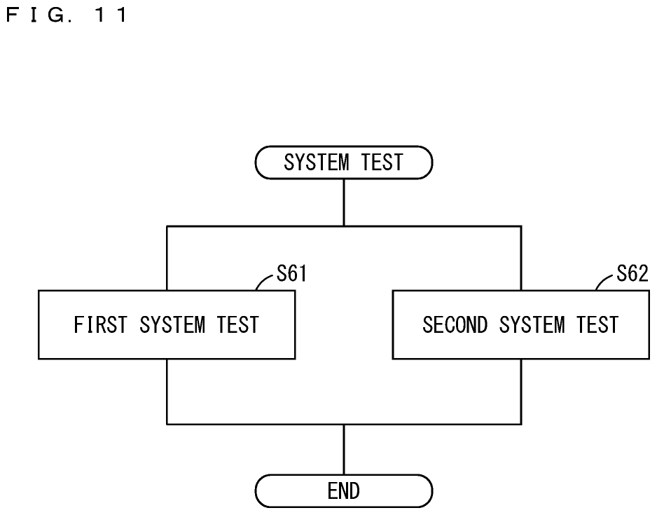

(a) While the first and second system tests are executed in series as successive execution of the plurality of system tests in the example of FIGS. 9 and 10, the first and second system tests may be executed in parallel as successive execution of the plurality of systems. FIG. 11 is a flowchart showing parallel execution of first and second system tests. As shown in FIG. 11, in parallel execution, the first system test (step S61) and the second system test (step S62) are temporally executed in parallel.

In this case, even in a case where the result of one system test out of the first system test and the second system test does not indicate passing, another system test is continued. Further, failing in regard to the system test is confirmed after all of the system tests end. In the present example, the overall execution period of time required for the plurality of system tests is shortened.

(b) While being are stored in the storage 14 in the above-mentioned embodiment, a plurality of report files and a plurality of executable files may be stored in an external server or a server on the Internet. In this case, the report file acquirer 103 acquires a report file from an external server, a server on the Internet or the like. The executable file acquirer 105 acquires an executable file from an external server, a server on the Internet or the like.

(c) While the analysis device 20 is a liquid chromatograph in the above-mentioned embodiment, the analysis device 20 may be another chromatograph such as a supercritical fluid chromatograph or an ion chromatograph, or another analysis device such as a mass spectrometer.

### (7) Correspondences between Constituent Elements in Claims and Parts in Preferred Embodiments

In the following paragraphs, non-limiting examples of correspondences between various elements recited in the claims below and those described above with respect to various preferred embodiments of the present disclosure are explained.

In the above-mentioned embodiment, the system test selector 102 is an example of a receiver, the report file acquirer 103 is an example of an acquirer, the display 16 is an example of a presenter and the test execution controller 106 is an example of an execution controller. Further, the report file creator 108 and the deviation report file creator 109 are examples of an outputter, and the evaluating condition confirmation screen 130, the executable file selection screen 140 and the advance preparation procedure screen 150 are examples of images showing the details of advance preparation.

### (8) Aspects

It is understood by those skilled in the art that the plurality of above-mentioned illustrative embodiments are specific examples of the below-mentioned aspects.

(Item 1) A qualification evaluating device according to one aspect that performs operational qualification evaluation in regard to an analysis device may include a receiver configured to be capable of receiving selection of a plurality of system tests for performing operational qualification evaluation in regard to a plurality of analysis systems constituted by the analysis device, an acquirer that acquires details of evaluation to be performed in the plurality of system tests received by the receiver as a plurality of evaluation information pieces, a presenter that presents details of advance preparation to be carried out before execution of the plurality of system tests based on the plurality of acquired evaluation information pieces, an execution controller that controls the analysis device such that the plurality of system tests are executed after the advance preparation for the plurality of system tests is completed, and an outputter that outputs results of the plurality of system tests executed by the execution controller.

With the qualification evaluating device according to one aspect, the details of advance preparation based on the plurality of evaluation information pieces acquired by the acquirer are presented by the presenter. The inspection performer can carry out advance preparation for the plurality of system tests in accordance with the details of the advance preparation presented by the presenter before execution of the plurality of system tests. Therefore, it is not necessary for the inspection performer to carry out the advance preparation for another system test after execution of each system test. Therefore, the plurality of system tests can be executed successively and automatically. As a result, operational qualification evaluation in regard to a plurality of analysis systems can be performed efficiently.

(Item 2) The qualification evaluating device according to item 1, wherein details of the advance preparation may include at least one of confirmation of evaluating conditions in the plurality of system tests, preparation work to be carried out in the analysis device in accordance with the plurality of system tests, and confirmation or a change of one or a plurality of executable files to be used for execution of the plurality of system tests.

With the qualification evaluating device according to item 2, work to be carried out by the inspection performer for the plurality of system tests can be carried out in one go. It is not necessary for the inspection performer to carry out work for another system test after execution of each system test.

(Item 3) The qualification evaluating device according to item 2, wherein the presenter may present an image showing details of the advance preparation for the plurality of system tests.

With the qualification evaluating device according to item 3, the inspection performer can visually identify the details of advance preparation for the plurality of system tests. This reduces a burden on the inspection performer.

(Item 4) The qualification evaluating device according to item 2 or 3, wherein the analysis device may include a separation column and a plurality of detectors, each of the plurality of analysis systems may include any one of the plurality of detectors, the preparation work may include preparation of one or a plurality of resistor tubes and enabling of selective connection of the separation column and each resistor tube to any one of the plurality of detectors, and the execution controller may control the analysis device such that the separation column or any one of resistor tubes is selectively connected to any one of the plurality of detectors in accordance with details of each system test.

With the qualification evaluating device according to item 4, the separation column or one of the resistor tubes is connected to the detector automatically by the presenter when the plurality of system tests are executed. Thus, it is not necessary for the inspection performer to connect the separation column CL or any one of the resistor tubes R1, R2 for another system test after execution of each system test. This reduces a burden on the inspection performer.

(Item 5) The qualification evaluating device according to any one of items 1 to 4, wherein the execution controller may control the analysis device such that the plurality of system tests are temporally executed in parallel or in series.

With the qualification evaluating device according to item 5, the total period of time required for the plurality of system tests can be reduced in accordance with the details of the plurality of system tests.

(Item 6) The qualification evaluating device according to item 5, wherein the execution controller may control the analysis device such that another system test is executed regardless of passing or failing indicated by a result of at least one system test.

With the qualification evaluating device according to item 6, even in a case where the result of at least one system test indicates failing, another system test is continued. Thus, the plurality of system tests are executed more efficiently.

(Item 7) The qualification evaluating device according to item 5 or 6, wherein the execution controller may control the analysis device such that at least one system test is re-executed in a case where a result of the at least one system test does not indicate passing.

With the qualification evaluating device according to item 7, in a case where the result of at least one system test indicates failing, the system test the result of which indicates failing is re-executed automatically. Thus, the inspection performer does not re-execute the system test the result of which indicates failing. Thus, a plurality of system tests are executed automatically without work of the inspection performer such that the results of the plurality of system tests indicate passing. As a result, operational qualification evaluation in regard to a plurality of analysis system can be performed more efficiently.

(Item 8) The qualification evaluating device according to any one of items 1 to 7, wherein the execution controller may control the analysis device such that the plurality of system tests are temporally executed in series or in parallel after the advance preparation is completed.

With the qualification evaluating device according to item 8, the plurality of system tests can be temporally executed in series or in parallel in accordance with the details of the plurality of system tests. As a result, the operational qualification evaluation in regard to the plurality of analysis system can be performed more efficiently.

(Item 9) A qualification evaluating method according to another aspect for performing operational qualification evaluation in regard to an analysis device may include receiving selection of a plurality of system tests for performing operational qualification evaluation in regard to a plurality of analysis systems constituted by the analysis device, acquiring details of evaluation to be performed in the plurality of received system tests as a plurality of evaluation information pieces, presenting details of advance preparation to be carried out before execution of the plurality of system tests based on the plurality of acquired evaluation information pieces, controlling the analysis device such that the plurality of system tests are executed after the advance preparation for the plurality of system tests is completed, and outputting results of the plurality of executed system tests.

With the qualification evaluating method according to item 9, the details of advance preparation based on the plurality of evaluation information pieces acquired by the acquirer are presented by the presenter. The inspection performer can carry out advance preparation for the plurality of system tests in accordance with the details of the advance preparation presented by the presenter before execution of the plurality of system tests. Therefore, it is not necessary for the inspection performer to carry out the advance preparation for another system test after execution of each system test. Therefore, the plurality of system tests can be executed successively and automatically. As a result, operational qualification evaluation in regard to a plurality of analysis systems can be performed efficiently.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/we claim:

1. A qualification evaluating device that performs operational qualification evaluation in regard to an analysis device, comprising:
a receiver configured to be capable of receiving selection of a plurality of system tests for performing operational qualification evaluation in regard to a plurality of analysis systems constituted by the analysis device;
an acquirer that acquires details of evaluation to be performed in the plurality of system tests received by the receiver as a plurality of evaluation information pieces;
a presenter that presents details of advance preparation to be carried out before execution of the plurality of system tests based on the plurality of acquired evaluation information pieces;
an execution controller that controls the analysis device such that the plurality of system tests are executed after the advance preparation for the plurality of system tests is completed; and
an outputter that outputs results of the plurality of system tests executed by the execution controller.

2. The qualification evaluating device according to claim 1, wherein
details of the advance preparation include at least one of confirmation of evaluating conditions in the plurality of system tests, preparation work to be carried out in the analysis device in accordance with the plurality of system tests, and confirmation or a change of one or a plurality of executable files to be used for execution of the plurality of system tests.

3. The qualification evaluating device according to claim 2, wherein
the presenter presents an image showing details of the advance preparation for the plurality of system tests.

4. The qualification evaluating device according to claim 2, wherein
the analysis device includes a separation column and a plurality of detectors,
each of the plurality of analysis systems includes any one of the plurality of detectors,
the preparation work includes preparation of one or a plurality of resistor tubes and enabling of selective connection of the separation column and each resistor tube to any one of the plurality of detectors, and
the execution controller controls the analysis device such that the separation column or any one of resistor tubes is selectively connected to any one of the plurality of detectors in accordance with details of each system test.

5. The qualification evaluating device according to claim 1, wherein
the execution controller controls the analysis device such that the plurality of system tests are temporally executed in parallel or in series.

6. The qualification evaluating device according to claim 5, wherein
the execution controller controls the analysis device such that another system test is executed regardless of passing or failing indicated by a result of at least one system test.

7. The qualification evaluating device according to claim 5, wherein
the execution controller controls the analysis device such that at least one system test is re-executed in a case where a result of the at least one system test does not indicate passing.

8. The qualification evaluating device according to claim 1, wherein
the execution controller controls the analysis device such that the plurality of system tests are temporally executed in series or in parallel after the advance preparation is completed.

9. A qualification evaluating method for performing operational qualification evaluation in regard to an analysis device, including:
receiving selection of a plurality of system tests for performing operational qualification evaluation in regard to a plurality of analysis systems constituted by the analysis device;
acquiring details of evaluation to be performed in the plurality of received system tests as a plurality of evaluation information pieces;
presenting details of advance preparation to be carried out before execution of the plurality of system tests based on the plurality of acquired evaluation information pieces;
controlling the analysis device such that the plurality of system tests are executed after the advance preparation for the plurality of system tests is completed; and
outputting results of the plurality of executed system tests.
